(19) United States
(12) Patent Application Publication
(10) Pub. No.: US 2023/0330641 A1
(43) Pub. Date: Oct. 19, 2023

(54) TRIMETAL SUPPORTED CATALYST

(71) Applicant: CHEVRON U.S.A. INC., San Ramon, CA (US)

(72) Inventors: Bi-Zeng ZHAN, Albany, CA (US); Bao LE, Pittsburg (US)

(21) Appl. No.: 18/042,715

(22) PCT Filed: Aug. 23, 2021
(86) PCT No.: PCT/US2021/047131

§ 371 Date: Feb. 23, 2023

Related U.S. Application Data
(60) Provisional application No. 63/070,610, filed on Aug. 26, 2020.

(51) Int. Cl. B01J 23/888; B01J 29/16; B01J 37/02; B01J 37/04; C10G 47/20

(52) U.S. Cl. CPC B01J 23/8885; B01J 29/166; B01J 37/0203; B01J 37/04; C10G 47/20; C10G 2400/04; C10G 2400/10; C10G 2300/308; C10G 2300/202; C10G 2300/301

(57) ABSTRACT

Provided is a novel catalyst comprised of an alumina, silica-alumina, and a zeolite containing base impregnated with Ni, Mo, and W. In one embodiment, the trimetallic catalyst is layered with a conventional hydrocracking pretreat catalyst to provide a catalyst combination useful in hydrotreating a feed to a hydrocracking stage.

### CROSS REFERENCE TO RELATED APPLICATIONS

This application is the national stage application of International Appl. No. PCT/US2021/047131 (doc. no. T-10457), filed on 23 Aug. 2021, and is related to, and claims priority benefit from U.S. Provisional Patent Appl. Ser. No. 63/070,610, filed on 26 Aug. 2020, entitled “TRIMETAL SUPPORTED CATALYST”, the disclosures of which are herein incorporated by reference in their entirety.

### FIELD OF THE INVENTION

The present disclosure relates to a novel trimetal supported catalyst which is useful in hydrocracking systems. Processes for preparing and using the trimetal supported catalyst are also disclosed.

### BACKGROUND

Hydrocracking of hydrocarbon feedstocks is often used to convert lower value hydrocarbon fractions into higher value products, such as conversion of vacuum gas oil (VGO) feedstocks to various fuels and lubricants. Hydrocracking refers to a process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins. Typical hydrocracking reaction schemes can include an initial hydrotreatment step, a hydrocracking step, and a post-hydrocracking step. After these steps, the effluent can be fractionated to separate out a desired diesel fuel and/or lubricating base oil.

Conventionally supported hydrocracking catalysts are prepared with Ni and W metals to provide hydrogenation functions in the C-C cracking process. Lately, Ni, Mo and W metals have been employed in the self-supported hydroprocessing catalyst through co-precipitation. See, for example, U.S. Pat. No. 9,919,987.

There is a demand, however, for new catalysts which can provide other improved functions such as HDN and HDS activity, as well as a dewaxing function.

### SUMMARY

Provided is a novel catalyst comprised of an alumina, silica-alumina, and a zeolite containing base impregnated with Ni, Mo, and W. In one embodiment, the trimetallic catalyst is layered with a conventional pretreat hydrocracking catalyst to provide a catalyst combination useful in pretreating a feed to a hydrocracker.

In one embodiment, the catalyst comprises from 2 to 10 wt. % Ni precursor; from 3-15 wt. % Mo precursor; and from 10 to 50 wt. % W precursor, based on the bulk dry weight of the catalyst. In another embodiment, the catalyst base comprises 0.1 to 40 wt. % alumina, 20 to 80 wt. % silica alumina, e.g., amorphous silica alumina (ASA), and 0.5 to 60 wt. % zeolite, e.g., USY zeolite, based on the dry wright of the base.

In another embodiment, there is provided a process comprising preparing a mixture of a molybdenum precursor and H₃PO₄; preparing an aqueous solution comprising a tungsten precursor and a nickel precursor; combining the solutions to form a trimetallic solution; and impregnating the base with the trimetallic solution.

In one embodiment, there is provided a hydrocracking process. The process comprises subjecting a hydrocarbon feed to a pretreatment reaction over a catalyst combination comprising the present catalyst layered with a hydrocracking pretreat catalyst. The resulting effluent is then passed from the pretreatment reaction zone to a hydrocracking zone. In the pretreatment reaction zone, the catalyst combination is layered with the hydrocracking pretreat catalyst the top layer, and the present trimetallic catalyst as the bottom layer.

Among other factors, the present catalyst can be used in hydrocracking systems to offer excellent pretreatment of the hydrocracking feed. Combining the present supported trimetallic catalyst with a conventional hydrocracking pretreat catalyst, or vacuum gas oil hydrotreating catalyst, as a layered combination, with the hydrocracking pretreat catalyst the top layer, has been found to offer improved HDN and HDS activity. Improved dewaxing of the feed has also been observed, allowing any subsequent dewaxing process in the system to be run at less harsh conditions.

### BRIEF DESCRIPTION OF THE DRAWINGS

FIG. 1 graphically compares the HDN activity in hydrotreating VGO1 feed over varying catalysts.

FIG. 2 graphically compares the HDS activity in hydrotreating VGO1 feed over varying catalysts.

FIG. 3 graphically compares wax content of a waxy base oil prepared using two lube hydrocracking catalyst systems.

### DETAILED DESCRIPTION

The present trimetallic supported catalyst is prepared from sources of nickel, molybdenum and tungsten in their compound or ionic form (“metal precursors”). Any suitable nickel, molybdenum or tungsten metal precursor can be used to prepare metal precursor solutions, e.g., any oxide or salt.

Examples of nickel precursors include oxides or sulfides of nickel, organic compounds of nickel (e.g., nickel naphthenate, nickelocene), nickel carbonate, nickel chloride, nickel hydroxide, nickel nitrate and nickel sulfate.

Examples of molybdenum precursors include oxides or sulfides of molybdenum, organic compounds of molybdenum (e.g., molybdenum naphthenate), sulfur-containing organic compounds of molybdenum (e.g., molybdenum dithiocarbamates, molybdenum dithiophosphates), molybdic acid, alkali metal or ammonium molybdates (e.g., sodium molybdate, ammonium molybdate, ammonium molybdate tetrahydrate, ammonium heptamolybdate, ammonium tetrathiomolybdate), Mo—P heteropolyanion compounds (e.g., phosphomolybdic acid, sodium phosphomolybdate, ammonium phosphomolybdate), Mo—Si heteropolyanion compounds (e.g., 12-molybdosilicic acid), and molybdenum chlorides.

Examples of tungsten precursors include oxides or sulfides of tungsten, organic compounds of tungsten (e.g., cyclopentadienyl tungsten dihydride), tungstic acid, alkali metal or ammonium tungstates (e.g., sodium tungstate, sodium polytungstate, ammonium tungstate, ammonium metatungstate, ammonium tetrathiotungstate), W—P heteropolyanion compounds (e.g., 12-tungstophosphoric acid), and tungsten chlorides.

The catalyst precursor may be prepared in the presence of an organic complexing or modifying agent (“L”). Preferably, the organic complexing agent is a metal binding group or chelating agent. Preferably, the organic complexing agent is a bidentate ligand. In one embodiment, the organic complexing agent is suitable for forming metal-ligand complexes in solution.

Organic acids are a preferred class of organic complexing agent. In one embodiment, the organic complexing agent is an organic acid that contains a carboxylic acid functional group and at least one additional functional group selected from carboxylic acid, hydroxamic acid, hydroxo, keto, amine, amide, imine, or thiol. Examples of organic complexing agents suitable for use herein include glyoxylic acid, glycolic acid, diglycolic acid, thioglycolic acid, pyruvic acid, oxalic acid, malonic acid, maleic acid, succinic acid, lactic acid, malic acid, tartaric acid, citric acid, glycine, oxamic acid, glyoxylic acid 2-oxime, ethylenediaminetetraacetic acid, nitrilotriacetic acid, N-methylaminodiacetic acid and iminodiacetic acid. A preferred organic acid is citric acid.

The amount of organic complexing agent used in the mixed solution should also be enough to form metal-organic complexes in the solution under reaction conditions. In an embodiment where the complexing agent is an organic acid, the ratio of carboxylic acid groups of the organic acids to metals can be at least 0.33, e.g., at least 0.5, at least about 1 (meaning that about the same number of carboxylic acid groups and metal atoms are present), at least 2, or at least 3. In another embodiment, the ratio of carboxylic acid groups to metals can be 12 or less (e.g., 10 or less, or 8 or less).

In another embodiment, the molar ratio used in the mixing solution of organic complexing agent to metals is 6:1 or less (e.g., 5.5:1 or less, 5:1 or less, or 4.5:1 or less). In yet another embodiment, the molar ratio used in the mixing solution of organic complexing agent to metals is 0.5:1 or more (e.g., 1:1 or more, or 1.5:1 or more, 2:1 or more, 2.5:1 or more, 3:1 or more, or 3.5:1 or more).

The amount of metal precursors and complexing or modifying agent (when employed) in the impregnation solution should be selected to achieve preferred ratios of metal to modifying agent in the catalyst precursor after drying.

The base of the catalyst, which is impregnated with the three metals, can comprise from about 0.1 to about 40 wt. % alumina base, based on the dry weight of the base, or in another embodiment from about 10 to about 30 wt. % alumina. About 25 wt. % alumina can be used in another embodiment. The base of the catalyst can also comprise from about 20 to about 80 wt. % of a silica alumina, based on the dry weight of the base, or in another embodiment from about 30 to about 80 wt. % silica alumina. Any suitable silica alumina can be used. In one embodiment the silica alumina is amorphous silica alumina (ASA). The zeolite can generally comprise from 0.5 to about 60 wt. % of the base, based on the dry weight of the base. In another embodiment, the zeolite can comprise from about 1 to about 50 wt. % of the base.

The alumina can be any alumina known for use in a catalyst base. For example, the alumina can be γ-alumina, η-alumina, θ-alumina, δ-alumina, χ-alumina, or a mixture thereof.

The silica alumina of the catalyst support is preferably in one embodiment an amorphous silica-alumina material in which the mean mesopore diameter is generally between 70 Å and 130 Å.

In one embodiment, the amorphous silica-alumina material contains SiO₂ in an amount of 10 to 70 wt. % of the bulk dry weight of the carrier as determined by ICP elemental analysis, a BET surface area of between 450 and 550 m²/g and a total pore volume of between 0.75 and 1.35 mL/g.

In another embodiment, the catalyst support comprises an amorphous silica-alumina material containing SiO₂ in an amount of 10 to 70 wt. % of the bulk dry weight of the carrier as determined by ICP elemental analysis, a BET surface area of between 450 and 550 m²/g, a total pore volume of between 0.75 and 1.35 mL/g, and a mean mesopore diameter is between 70 Å and 130 Å.

In another embodiment, the catalyst support is a highly homogeneous amorphous silica-alumina material having a surface to bulk silica to alumina ratio (S/B ratio) of 0.7 to 1.3, and a crystalline alumina phase present in an amount no more than about 10 wt. %.

$$S / B Ratio = \frac{( Si / Al atomic ratio of the surface area measured by XPS )}{( Si / Al atomic ratio of the bulk measured by elemental analysis )}$$

To determine the S/B ratio, the Si/AI atomic ratio of the silica-alumina surface is measured using x-ray photoelectron spectroscopy (XPS). XPS is also known as electron spectroscopy for chemical analysis (ESCA). Since the penetration depth of XPS is less than 50 Å, the Si/AI atomic ratio measured by XPS is for the surface chemical composition.

Use of XPS for silica-alumina characterization was published by W. Daneiell et al. in Applied Catalysis A, 196, 247-260, 2000. The XPS technique is, therefore, effective in measuring the chemical composition of the outer layer of catalytic particle surface. Other surface measurement techniques, such as Auger electron spectroscopy (AES) and Secondary-ion mass spectroscopy (SIMS), could also be used for measurement of the surface composition.

Separately, the bulk Si/AI ratio of the composition is determined from ICP elemental analysis. Then, by comparing the surface Si/Al ratio to the bulk Si/Al ratio, the S/B ratio and the homogeneity of silica-alumina are determined. How the SB ratio defines the homogeneity of a particle is explained as follows. An S/B ratio of 1.0 means the material is completely homogeneous throughout the particles. An S/B ratio of less than 1.0 means the particle surface is enriched with aluminum (or depleted with silicon), and aluminum is predominantly located on the external surface of the particles. The S/B ratio of more than 1.0 means the particle surface is enriched with silicon (or depleted with aluminum), and aluminum is predominantly located on the internal area of the particles.

The zeolite can be any suitable zeolite used in hydrocracking catalysts. For example, the zeolite can be a USY zeolite, a beta zeolite, ZSM-12, ZSM-22, ZSM-48, SSZ-33, SSZ-41, SSZ-42, SSZ-53, SSZ-60, SSZ-65, SSZ-70, SSZ-82, SSZ-91, SSZ-109, a mordenite zeolite, and mixtures thereof. A USY zeolite is preferred in one embodiment.

“Zeolite USY” refers to ultra-stabilized Y zeolite. Y zeolites are synthetic faujasite (FAU) zeolites having a SAR of 3 or higher. Y zeolite can be ultra-stabilized by one or more of hydrothermal stabilization, dealumination, and isomorphous substitution. Zeolite USY can be any FAU-type zeolite with a higher framework silicon content than a starting (as-synthesized) Na-Y zeolite precursor. Such suitable Y zeolites are commercially available from, e.g., Zeolyst, Tosoh and JGC.

The base is impregnated with the three metals to produce the present supported trimetallic catalyst. In one embodiment, the process for preparing the catalyst comprises preparing two solutions. One solution comprises a mixture of a molybdenum (Mo) precursor and H₃PO₄. The presence of the H₃PO₄ allows for a clear solution. The other solution is an aqueous solution comprising a tungsten (W) precursor and a nickel (Ni) precursor. The two solutions are combined to form a trimetallic solution. It has been found that the presence of the H₃PO₄ aids in the resulting trimetallic solution being clear. The base is then impregnated with the trimetallic solution using conventional impregnation techniques.

In one embodiment, the molybdenum precursor is ammonium molybdate tetrahydrate. In one embodiment, the tungsten precursor is ammonium metatungstate. In one embodiment, the nickel precursor is nickel carbonate.

In another embodiment, an organic acid is also added to the aqueous solution comprising the tungsten and nickel precursors as a complexing or modifying agent. Citric acid is one such organic acid often used.

The loading of the solutions is such that the ultimate catalyst comprises from 2 to 10 wt. % Ni precursor; from 3-15 wt. % Mo precursor; and 10 to 50 wt. % W precursor, based on the bulk dry weight of the catalyst. The molar ratio of W to Mo in the catalyst generally ranges from about 1.2 to about 4.0. If the ultimate catalyst is calcined to produce metal oxides, the loading is such that the final catalyst comprises from 2-10 wt. % NiO, 3-15 wt. % MoO₃, and 15-40 wt. % WO3 based on the bulk dry weight of the catalyst. With oxides, the weight ratio of WO₃ to MoO₃ generally ranges from about 2.0 to about 6.4. Generally, when an organic acid is used in the impregnation, calcination to oxides is not employed.

More specifically, the base is prepared with its components and often extruded. The extrudate is exposed to the impregnation solution until incipient wetness is achieved, typically for a period of between 0.5 and 100 hours (more typically between 1 and 5 hours) at room temperature to 212° F. (100° C.) while tumbling the extrudates, following by aging for from 0.1 to 10 hours, typically from about 0.5 to about 5 hours.

The drying step is conducted at a temperature sufficient to remove the impregnation solution solvent, but below the decomposition temperature of the modifying agent. In another embodiment, the dried impregnated extrudate is then calcined at a temperature above the decomposition temperature of the modifying agent, if used, typically from about 500° F. (260° C.) to 1100° F. (590° C.), for an effective amount of time. The present invention contemplates that when the impregnated extrudate is to be calcined, it will undergo drying during the period where the temperature is being elevated or ramped to the intended calcination temperature. This effective amount of time will range from about 0.5 to about 24 hours, typically from about 1 to about 5 hours. The calcination can be carried out in the presence of a flowing oxygen-containing gas such as air, a flowing inert gas such as nitrogen, or a combination of oxygen-containing and inert gases.

In one embodiment, the impregnated extrudate is calcined at a temperature which does not convert the metals to metal oxides. Yet in another embodiment, the impregnated extrudate can be calcined at a temperature sufficient to convert the metals to metal oxides.

The dried and calcined catalysts of the present invention can be sulfided to form an active catalyst. Sulfiding of the catalyst precursor to form the catalyst can be performed prior to introduction of the catalyst into a reactor (thus ex-situ presulfiding), or can be carried out in the reactor (in-situ sulfiding).

Suitable sulfiding agents include elemental sulfur, ammonium sulfide, ammonium polysulfide ([(NH₄)₂Sₓ), ammonium thiosulfate ((NH₄)Na₂S₂O₃), sodium thiosulfate (Na₂S₂O₃), thiourea CSN₂H₄, carbon disulfide, dimethyl disulfide (DMDS), dimethyl sulfide (DMS), dibutyl polysulfide (DBPS), mercaptanes, tertiarybutyl polysulfide (PSTB), tertiarynonyl polysulfide (PSTN), aqueous ammonium sulfide.

Generally, the sulfiding agent is present in an amount in excess of the stoichiometric amount required to form the sulfided catalyst. In another embodiment, the amount of sulfiding agent represents a sulphur to metal mole ratio of at least 3 to 1 to produce a sulfided catalyst.

The catalyst is converted into an active sulfided catalyst upon contact with the sulfiding agent at a temperature of 150° F. to 900° F. (66° C. to 482° C.), from 10 minutes to 15 days, and under a Hz-containing gas pressure of 101 kPa to 25,000 kPa. If the sulfidation temperature is below the boiling point of the sulfiding agent, the process is generally carried out at atmospheric pressure. Above the boiling temperature of the sulfiding agent/optional components, the reaction is generally carried out at an increased pressure. As used herein, completion of the sulfidation process means that at least 95% of stoichiometric sulfur quantity necessary to convert the metals into for example, CO₉S₈, MoS₂, WS₂, Ni₃S₂, etc., has been consumed.

In one embodiment, the sulfiding can be carried out to completion in the gaseous phase with hydrogen and a sulfur-containing compound which is decomposable into H₂S. Examples include mercaptanes, CS₂, thiophenes, DMS, DMDS and suitable S-containing refinery outlet gasses. The gaseous mixture of H₂ and sulfur containing compound can be the same or different in the steps. The sulfidation in the gaseous phase can be done in any suitable manner, including a fixed bed process and a moving bed process (in which the catalyst moves relative to the reactor, e.g., ebullated process and rotary furnace).

The contacting between the catalyst precursor with hydrogen and a sulfur-containing compound can be done in one step at a temperature of 68° F. to 700° F. (20° C. to 371° C.) at a pressure of 101 kPa to 25,000 kPa for a period of 1 to 100 hrs. Typically, sulfidation is carried out over a period of time with the temperature being increased or ramped in increments and held over a period of time until completion.

In another embodiment sulfidation can be in the gaseous phase. The sulfidation is done in two or more steps, with the first step being at a lower temperature than the subsequent step(s).

In one embodiment, the sulfidation is carried out in the liquid phase. At first, the catalyst precursor is brought in contact with an organic liquid in an amount in the range of 20% to 500% of the catalyst total pore volume. The contacting with the organic liquid can be at a temperature ranging from ambient to 248° F. (120° C.). After the incorporation of an organic liquid, the catalyst precursor is brought into contact with hydrogen and a sulfur-containing compound.

In one embodiment, the organic liquid has a boiling range of 200° F. to 1200° F. (93° C. to 649° C.). Exemplary organic liquids include petroleum fractions such as heavy oils, lubricating oil fractions like mineral lube oil, atmospheric gas oils, vacuum gas oils, straight run gas oils, white spirit, middle distillates like diesel, jet fuel and heating oil, naphtha, and gasoline. In one embodiment, the organic liquid contains less than 10 wt. % sulfur, and preferably less than 5 wt. %.

The present catalyst is useful in hydrocracking systems. It can be used as a hydrocracking catalyst in a hydrocracking zone. Particular use has been discovered when the present trimetal supported catalyst is combined with a conventional hydrocracking pretreat catalyst as a layered combination. In particular, the conventional pretreat catalyst is the top layer and meets the hydrocracking feed first. This layered combination is advantageously used in the pretreating or hydrotreating zone of a hydrocracking reaction stage. The top layer catalyst can generally comprise from 60-85 vol. % of the layered combination, and the present catalyst from 15-40 vol. %. Preferred is an 80 vol. % to 20 vol. % combination.

The conventional pretreat catalyst of the top layer can be any conventional catalyst used in the pretreat or hydrotreating zone of a hydrocracking system to effect hydrodenitrogenation and/or hydrodesulfurization. Such conventional pretreat catalysts do not comprise the trimetallic combination of the present catalyst. Examples of such pretreat or hydrotreating catalysts include ICR 513, ICR 514, and ICR 1000 series available from ART; ExxonMobil catalysts available under the trademarks Celestia®, Nebula®, and MIDW®; and the Albermarle catalysts KF 880 and KF 870. Combining/layering such a catalyst with the present catalyst has been found to be quite advantages.

The present combination catalyst has been found to have particular application in hydrocracking processes as the pretreatment or hydrotreating zone. Once the feed passes the layered combination, the resulting effluent is passed onto a hydrocracking zone. The pretreatment zone is operated under conventional conditions of temperature and pressure for a pretreatment or hydrotreating zone. Particular application has also been found for hydrocracking feeds designed for producing a diesel fuel or a lubricating base oil.

### EXAMPLES

The following illustrative examples are intended to be non-limiting.

### Example 1

### Preparation of Alumina Catalyst Support A

Catalyst Support A was prepared according to US2014/0367311 A1. An alumina containing slurry was prepared as follows: to a tank was added 13630 L of city water. The temperature was brought to 120° F. (49° C.) with heating. An aluminum sulfate stream and a sodium aluminate stream are added continuously to the tank under agitation. The aluminum sulfate stream consists of an aqueous solution of aluminum sulfate (containing 8.3 wt. % Al₂O₃, 76 L/min) inline diluted with water (79.9 L/min), while the sodium aluminate stream was composed of an aqueous solution of sodium aluminate (containing 25.5 wt. % Al₂O₃) inline diluted with water (134 L/min). The addition speed of the sodium aluminate solution in the sodium aluminate stream was controlled by the pH of the alumina slurry. The pH was controlled at 9.0 and temperature at 120° F. (49° C.). The temperature control was achieved through adjusting the temperature of dilution water for both streams. After 2,082 L of the aqueous solution of sodium aluminate was added to the tank, both aluminum sulfate and sodium aluminate streams are stopped. The temperature of the resulting slurry was increased to 127° F. (53° C.) with steam injection for 35 min. Both aluminum sulfate and sodium aluminate streams are resumed while the steam injection was kept on. During this step, the pH of the slurry was kept at 9.0, while the temperature was allowed to rise freely. The precipitation was stopped once 4542 L of the aqueous aluminum sulfate solution was added. The final temperature of the slurry reaches 149° F. (65° C.). After the precipitation was stopped, the pH was raised with addition of the same aqueous sodium aluminate to 9.3. The alumina slurry was then filtered and washed to remove Na⁺ and SO₄²⁻. This slurry is referred to as slurry A.

After about half of slurry A was pumped to another tank, it was heated to 140-151° F. (60-66° C.) with steam injection and maintained at this temperature. MS-25 silica-alumina (63.5 kg, from W. R. Grace) was added to the tank. The amount of MS-25 was controlled so that the final support contained 3% SiO₂. Acetic acid (113 kg, 29.2%) was subsequently added to the slurry before it was agitated for 30 min. After the agitation, ammonia (60.8 kg, 6.06%) was added before the slurry was filtered to give a cake. The obtained cake was dried at about 550° F. (288° C.) to give an alumina powder containing about 60% moisture. The powder was next transferred to a mixer and treated with 0.5% HNO3 and 10% of recycle catalyst/support fines. The mixture was kept mixing until an extrudable mixture was formed. The mixture was then extruded in 1/16″ asymmetric quadrilobe shape, dried, and calcined at 1350° F. (732° C.) to give a catalyst Support A.

### Example 2

### Preparation of Alumina Catalyst Support B

Alumina Support B was prepared in the same way as alumina Support A. The difference is the drying step changed from spray dry to holoflite dry at comparable temperature to produce an alumina powder containing about 60% moisture. This drying process produced alumina powder with a slightly higher pore volume and larger pore size. The powder was then transferred to a mixer and treated with 0.5% HNO₃ and 10% of recycle catalyst/support fines. The mixture was kept mixing until an extrudable mixture was formed. The mixture was then extruded in 1/16″ asymmetric quadrilobe shape, dried, and calcined at 1350° F. (732° C.) to give the catalyst Support B.

### Example 3

### Preparation of Zeolite-Containing Hydrocracking Catalyst Support C

A hydrocracking catalyst Support C was prepared according to method described in U.S. Pat. No. 9,187,702 B2. Silica-alumina powder (obtained from Sasol, PIDC, JGC) of 67 g (dry weight, weighed after drying the sample at 1099° F. (593° C.), pseudo boehmite alumina powder (obtained from Sasol) of 25 g (dry weight) and 8 g of zeolite Y (from Zeolyst, JGC, Tosoh) were mixed well. A 1M HNO₃ acid aqueous solution (1 wt. % of dry catalyst support) was added to the mix powder to form an extrudable paste. The paste was extruded in 1/16″ asymmetric quadrilobe shape and dried at 248° F. (120° C.) overnight. The dried extrudates were calcined at 1099° F. (593° C.) for 1 h with purging excess dry air and cooled down to room temperature to give the Support C.

### Example 4

### Preparation of Zeolite-Containing Hydrocracking Catalyst Support D

A hydrocracking catalyst Support D was prepared in the same way as catalyst Support C except for using a high pore-volume silica-alumina powder of 67 g (dry weight, weighed after drying the sample at 1099° F. (593° C.), pseudo boehmite alumina powder (obtained from Sasol) of 25 g (dry weight) and 8 g of zeolite Y (from Zeolyst, JGC, Tosoh) were mixed well. A 1 M HNO3 acid aqueous solution (1 wt. % of dry catalyst support) was added to the mix powder to form an extrudable paste. The paste was extruded in 1/16″ asymmetric quadrilobe shape and dried at 248° F. (120° C.) overnight. The dried extrudates were calcined at 1099° F. (593° C.) for 1 h with purging excess dry air and cooled down to room temperature to give the catalyst Support D.

### Example 5

### Preparation of Hydrocracking Pretreat Catalyst A (NIₓMO_{y}P)

The Catalyst A was impregnated with an aqueous Ni—Mo—P metal solution on catalyst Support A. The detailed preparation is described in WO2015/164464 A1. 116.7 g of citric acid was added to 400 mL of water in a round bottom flask equipped with stirrer. 194.75 g of nickel carbonate (49% Ni) was added to the above solution. 189.34 g of phosphoric acid (85%) was then added slowly to the solution and the solution was heated to 150° F. (66° C.). Then, 475.95 g of molybdenum trioxide was added to the solution. The solution was heated to about 190° F. to 210° F. and held at that temperature range for at least 1.5 h until the solution became clear. Once the solution became clear, it was cooled to below 120° F. (49° C.) and an additional 272.8 g of citric acid was added and the mixture was stirred until the solution became clear. The solution was diluted with deionized water to 1000 mL. The final MoO₃ concentration was 0.4750 g/mL of solution. Analysis of the resulting NiₓMO_{y}P_{z} solution showed the following composition (metals expressed as the oxides): concentration in wt. % on a dry basis: NiO, 6.0; P₂O₅ 6.5; MoO₃, 25.0. The solution contained the following component ratio: 0.4 citric acid/(NiO+MoO₃) (mol/mol).

Catalyst A was prepared by impregnating the catalyst Support A using the NiₓMO_{y}P_{z} solution. The support was impregnated by the incipient wetness method, e.g., the total volume of the metal solution matches the 103% water pore volume of the support extrudates. Then the wet extrudates were heated in air at 320° F. (160° C.) for ten minutes, ramped to 680° F. (360° C.) over 40 minutes, and held at 680° F. (360° C.) for 10 minutes to produce Catalyst A.

### Example 6

### Preparation of Hydrocracking Pretreat Catalyst B (NIₓMO_{y}P)

The Catalyst B was prepared with the same metal solution, metal loading and calcination conditions as the Catalyst A. The only difference is the use of catalyst Support B.

### Example 7

### Preparation of Hydrocracking Catalyst C (NIₓW_{y} With Citric Acid)

NiW hydrocracking Catalyst C was prepared with catalyst Support C. Impregnation of Ni and W was done using an aqueous solution containing ammonium metatungstate and nickel carbonate to the target metal loadings of 6.0 wt. % NiO and 22.0 wt. % WO3 in the finished catalyst. Citric acid at the amount of 12.2 wt. % of finished dry catalyst was added to the NiW solution. The solution was heated to above 122° F. (50° C.) to ensure a completed dissolved (clear) solution. The total volume of the metal solution matches the 103% water pore volume of the base extrudates (incipient wetness method). The metal solution was added to the support extrudates gradually while tumbling the extrudates. When the solution addition was completed, the soaked extrudates are aged for 2 h. Then the wet extrudates were heated in air at 320° F. (160° C.) for ten minutes, ramped to 680° F. (360° C.) over 40 minutes, and held at 680° F. (360° C.) for 10 minutes to produce the Catalyst C.

### Example 8

### Preparation of Hydrocracking Catalyst D (NIₓW_{y}MO_{z}P WITH CITRIC ACID)

Trimetallic (NiWMo) hydrocracking Catalyst D was prepared with the catalyst Support C, same as hydrocracking Catalyst C. Two aqueous solutions were prepared separately and then mixed together before impregnation. MoP solution was prepared by mixing the required amount of ammonium molybdate tetrahydrate and 85% H₃PO₄ together to form a clear solution. The NiW solution was prepared the same way as that for the Catalyst C. The two clear solutions were combined together to form a trimetallic solution. The total volume of the trimetallic solution matches the 103% water pore volume of the base extrudates (incipient wetness method). The metal solution was added to the catalyst Support C gradually while tumbling the extrudates. When the solution addition was completed, the soaked extrudates are aged for 2 h. Then the wet extrudates were heated in air at 320° F. (160° C.) for ten minutes, ramped to 680° F. (360° C.) over 40 minutes, and held at 680° F. (360° C.) for 10 minutes to produce the Catalyst D. The target metal loadings are 19.0 wt. % WO₃, 4.8 wt. % MoO₃, 4.2% NiO and 1.0 wt. % P₂O₅. Citric acid at the amount of 8.5 wt. % of finished dry catalyst was added to the NiW solution.

### Example 9

### Preparation of Hydrocracking Catalyst E (NIₓW_{y}MO_{z}P Without Citric Acid)

Trimetallic (NiWMo) hydrocracking Catalyst E was prepared with the catalyst Support C, same as hydrocracking Catalyst D. Two aqueous solutions were prepared separately and then mixed together before impregnation. MoP solution was prepared by mixing the required amount of ammonium molybdate tetrahydrate and 85% H₃PO₄ together to form a clear solution. The NiW solution was prepared without citric acid, different from the Catalyst C and D. The aqueous NiW solution was prepared by mixing the required amount of nickel nitrate hexahydrate and ammonium metatungstate in water. The two clear solutions were combined together to form a trimetallic solution. The total volume of the trimetallic solution matches the 103% water pore volume of the base extrudates (incipient wetness method). The metal solution was added to the catalyst Support C gradually while tumbling the extrudates. When the solution addition was completed, the soaked extrudates are aged for 2 h. Then the wet extrudates were heated in air at 320° F. (160° C.) for ten minutes, ramped to 680° F. (450° C.) over 40 minutes, and held at 842° F. (360° C.) for 10 minutes to produce the Catalyst E. The target metal loadings are 21.7 wt. % WO₃, 5.5 wt. % MoO₃, 4.8% NiO and 1.2 wt. % P₂O₅.

### Example 10

### Preparation of Hydrocracking Catalyst F (NIₓW_{y}MO_{z}P Without Citric Acid)

Trimetallic (NiWMo) hydrocracking catalyst F was prepared with the catalyst support D. The trimetallic solution is the same as that for the Catalyst E except at a higher concentration so as to target metal loadings of 31.2 wt. % WO₃, 8.0 wt. % MoO₃, 6.8% NiO and 1.8 wt. % P₂O₅.

TABLE 1
SUMMARY OF CATALYST COMPOSITE AND METAL LOADING

| | Catalyst | Metal Loading, wt. % | | | | |
|---|---|---|---|---|---|---|
| Sample ID | Support | NiO | WO₃ | MoO₃ | P₂O₅ | Citric acid |
| Catalyst A | Support A | 6.0 | — | 25.0 | 6.5 | Yes |
| Catalyst B | Support B | 6.0 | — | 25.0 | 6.5 | Yes |
| Catalyst C | Support C | 6.0 | 22.0 | — | — | Yes |
| Catalyst D | Support C | 4.2 | 19.0 | 4.8 | 1.0 | Yes |
| Catalyst E | Support C | 4.8 | 21.7 | 5.5 | 1.2 | No |
| Catalyst F | Support D | 6.8 | 31.2 | 6.8 | 1.8 | No |

### Example 11

### Hydrocarbon Vacuum Gas Oil Samples

Two vacuum gas oils were used for the series of studies. VGO1 was a straight run VGO directly from the crude distillation. VGO2 was a feed blend of a straight run VGO and heavy coker gas oil. Their properties are listed in Table 2.

TABLE 2
PROPERTIES OF VGO FEEDS

| | | |
|---|---|---|
| Hydrocarbon feed | VGO1 | VGO2 |

| | | |
|---|---|---|
| Density, g/mL | 0.924 | 0.942 |
| Nitrogen content, PPM | 997 | 1280 |
| Sulfur content, wt. % | 2.21 | 2.53 |
| Hydrogen content, wt. % | 12.27 | 11.88 |

Components by Mass Spectrometer, Vol %

| | | |
|---|---|---|
| Paraffins | 14.9 | 39.7 |
| Naphthenes | 29.0 | 33.1 |
| Aromatics | 35.3 | 10.5 |
| Sulfur compounds | 20.0 | 16.6 |

Simulated Distillation, ° F. (° C.) @ wt %

| | | | | |
|---|---|---|---|---|
| IBP | 626 | (330) | 615 | (323) |
| 5% | 689 | (365) | 736 | (391) |
| 10% | 723 | (384) | 780 | (416) |
| 30% | 792 | (422) | 866 | (463) |
| 50% | 842 | (450) | 921 | (494) |
| 70% | 896 | (480) | 971 | (522) |
| 90% | 973 | (523) | 1040 | (560) |
| 95% | 1009 | (543) | 1071 | (577) |
| EP | 1089 | (587) | 1138 | (614) |

### Example 12

### Hydrocracking Pretreat (HDN/HDS) Activity Study

The hydrotreating performance evaluation was conducted using an in-house designed fixed-bed hydroprocessing unit equipped with an automated catalyst and distillation system. Catalyst extrudates (L/D=1-2) of a total of 6 mL are loaded to a stainless-steel reactor. The catalyst bed was packed with 100-mesh alundum to improve feed-catalyst contact and to prevent channeling and was placed in the isothermal zone of furnace. Hydrocracking pretreat catalyst evaluation conditions are listed below:
Feed: VGO1
Inlet hydrogen pressure: 2300 PSIG
Hydrogen partial pressure: 2180 PSIA
Hydrogen to oil ratio: 5000 SCFB
Feed rate: 2.0 LHSV

Testing target: 20 ppm N in hydrotreated product for hydrodenitrogenation (HDN) activity comparison or 500 ppm S in hydrotreated product for hydrodesulfurization (HDS) activity comparison

The liquid product was sent to an on-line distillation for a cut point controlled at 600° F. (316° C.). Samples from the distillation overhead (DO), distillation bottom (DB), and off gas are collected and analyzed daily for Simdist, N and S for hydrocracking (HCR) conversion, HDN, and HNS activity calculation. Reactor temperature was controlled in the range of 700 to 740° F. (371 to 393° C.) for all the six catalysts listed in Table 1. Three layered catalyst systems, Catalysts A/D, Catalysts B/D and Catalysts B/F were also evaluated. The layered catalyst system was configurated at 80/20 volume ratio with 80 vol. % of Catalyst A or Catalyst B on top of 20 vol. % of Catalyst D or Catalyst F as shown in the chart below.

Catalysts A or B
(80 vol. %)
Catalysts D or F
(20 vol. %)

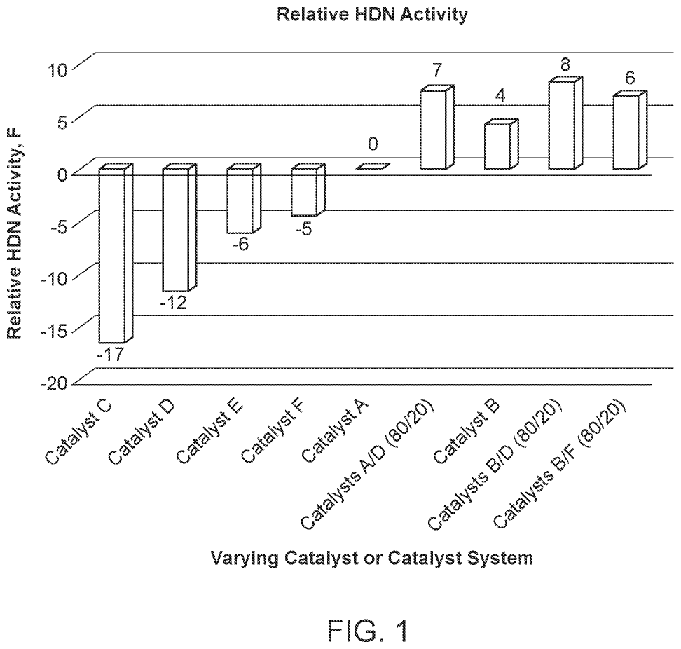

The layered catalyst systems in the study and the results of the HDN study are shown in FIG. 1, which is a comparison of HDN activity in hydrotreating VGO1 over the varying catalysts used. Catalyst activity is compared based on the temperature required to produce 20 ppm N in the hydrotreated product. Positive value suggests the catalyst is more active in HDN than the base case of Catalyst A.

The results in FIG. 1 show that 1) trimetallic hydrocracking Catalyst D showed higher hydrodenitrogenation (HDN) activity than bimetallic hydrocracking Catalyst C at the comparable total metal loading. 2) trimetallic hydrocracking Catalysts D, E, and F alone (NiₓW_{y}MO_{z}P) was less active than the conventional alumina-supported hydrocracking pretreat Catalysts A and B (NiₓMo_{y}P). But all three of the layered catalyst systems (A/D, B/D and B/F) were more active than the pretreat Catalysts A and B (NiₓMo_{y}P). It suggests the synergetic effect between NiₓMy_{P}hydrotreating catalyst and NiₓW_{y}Mo_{z}P hydrocracking catalyst for HDN application.

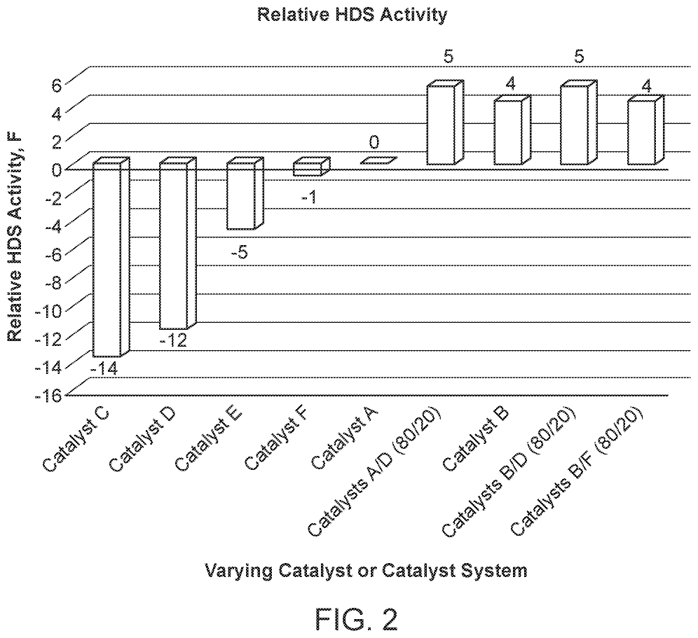

The results of the HDS study are shown in FIG. 2, which is a comparison of HDS activity in hydrotreating VGO1 over varying catalysts. Catalyst activity is compared based on the temperature required to produce 500 ppm S in the hydrotreated product. Positive value suggests the catalyst is more active in HDS than the base case of Catalyst A.

Based on the results shown in FIG. 2, a similar conclusion can be made for hydrodesulfurization (HDS). 1) Trimetallic hydrocracking Catalyst D showed higher HDS activity than bimetallic hydrocracking Catalyst C at the comparable total metal loading. 2) All three of the layered catalyst systems (A/D, B/D and B/F) were more active than the pretreat Catalysts A and B (NiₓMo_{y}P), indicating the synergetic effect between NiₓMo_{y}P hydrotreating catalyst and NiₓW_{y}Mo_{z}P hydrocracking catalyst for HDS application.

### Example 13

### Hydrocracking for a Base Oil Study

VGO2 was used for lube hydrocracking study for producing waxy base oil 220R and 600R with process conditions below:
Feed: VGO2
Inlet hydrogen pressure: 2100 PSIG
Hydrogen partial pressure: 2000 PSIA
Hydrogen to oil ratio: 5000 SCFB
Feed rate: 0.65 LHSV
Testing target: >110 VI for waxy base oil 220R (˜6 cSt. at 100° C.)

Two catalyst systems were tested for comparison. For the base case, Catalyst A was used as lube HCR pre-treat and post-treat as shown in the scheme below. The catalyst loadings are: Demetallization (Demet) catalyst/Catalyst A/Lube HCR catalyst/Catalyst A=10/39/40/11 vol. %. An ART Demetallization (Demet) catalyst was used at the top of lube hydrocracker for metal impurity management. An ART hydrocracking catalyst was used for VI upgrading. For the new case, the only change is that Catalyst A was partially replaced by Catalyst D as lube HCR pre-treat. The ratio of Catalyst A to Catalyst D is 4 to 1 by volume, e.g., the same ratio as that used for the hydrocracking pretreat study with the VGO1 feedstock. The intent is to utilize the synergistic HDN/HDS activity benefit as observed in the previous section.

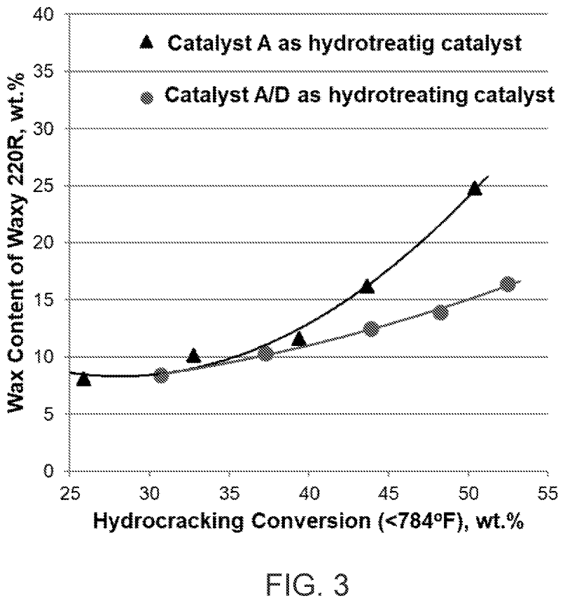

Beside the advantage of HDN/HDS activity of the layering system, it was also found that the wax content of the produced waxy base oil over the present catalyst system was greatly lower than that from the base case. The wax content reduction gradually increased with increased hydrocracking conversion as shown in FIG. 3. The wax content reduction can be attributed to the isomerization over acidic sites generated by trimetallic NiₓW_{y}Mo_{z} components.

It will be understood that the invention is not limited to the embodiments described above and various modifications and improvements can be made without departing from the concepts described herein. Except where mutually exclusive, any of the features may be employed separately or in combination with any other features and the disclosure extends to and includes all combinations and sub-combinations of one or more features described herein.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

1. A catalyst comprised of an alumina, silica-alumina, and a zeolite containing base impregnated with Ni, Mo, and W.

2. The catalyst of claim 1, wherein the catalyst comprises 2-10 wt. % NiO; 3-15 wt. % MoO₃; 15-40 wt. % WO₃, based on the bulk dry weight of the catalyst.

3. The catalyst of claim 2, wherein the weight ratio of WO₃ to MoO₃ is from 2.0 to 6.4.

4. The catalyst of claim 1, wherein the catalyst comprises from 2 to 10 wt. % Ni precursor; from 3-15 wt. % Mo precursor; and from 10 to 50 wt. % W precursor, based on the bulk dry weight of the catalyst.

5. The catalyst of claim 4, wherein the molar ratio of W to Mo in the catalyst ranges from 1.2 to 4.0.

6. The catalyst of claim 2, wherein the base comprises 0.1 to 40 wt. % alumina, 20 to 80 wt. % silica alumina, and 0.5 to 60 wt. % zeolite, based on the dry weight of the base.

7. The catalyst of claim 6, wherein the zeolite comprises an USY zeolite, a beta zeolite, ZSM-12, ZSM-22, ZSM-48, SSZ-33, SSZ-41, SSZ-42, SSZ-53, SSZ-60, SSZ-65, SSZ-70, SSZ-82, SSZ-91, SSZ-109, a mordenite zeolite, or a mixture thereof.

8. The catalyst of claim 7, wherein the zeolite comprises an USY zeolite.

9. The catalyst of claim 6, wherein the base comprises 10 to 30 wt. % alumina, 30 to 80 wt. % ASA; and 1 to 50 wt. % USY zeolite, based on the dry weight of the base.

10. The catalyst of claim 2 or 4, further comprising an organic acid.

11. The catalyst of claim 10, wherein the organic acid comprises citric acid.

12. A process for preparing the catalyst of claim 1, comprising:
(i) preparing a solution comprising a mixture of a molybdenum precursor and H₃PO₄;
(ii) preparing an aqueous solution comprising a tungsten precursor and a nickel precursor;
(iii) combining the solutions (i) and (ii) to form a trimetallic solution; and
(iv) impregnating the base with the trimetallic solution.

13. The process of claim 12, comprising:
(i) preparing a solution comprising a mixture of ammonium molybdate tetrahydrate and H₃PO₄;
(ii) preparing an aqueous solution of ammonium metatungstate and nickel precursor;
(iii) combining the solutions (i) and (ii) to form a trimetallic solution; and
(iv) impregnating the base with the trimetallic solution.

14. The process of claim 12 or 13, further comprising adding an organic acid to the aqueous solution of (ii).

15. The process of claim 14, wherein the organic acid comprises citric acid.

16. A hydrocracking process, comprising:
(i) subjecting a hydrocarbon feed to a pretreatment reaction over a catalyst combination comprising the catalyst of claim 1 layered with a hydrocracking pretreat catalyst; and
(ii) passing effluent from the pretreatment reaction to a hydrocracking zone.

17. The hydrocracking process of claim 16, wherein the catalyst combination is layered with the hydrocracking pretreat catalyst on the top layer.

18. The process of claim 17, wherein the feed is designed for producing a hydrocracked diesel fuel product.

19. The process of claim 17, wherein the feed is designed for producing a waxy base oil product.

20. A process for hydrotreating a hydrocarbon feed, comprising subjecting the hydrocarbon feed under hydrotreating conditions to the catalyst of claim 1 layered with a hydrocracking pretreat catalyst.

21. A catalyst combination comprising the catalyst of claim 1 layered with a pretreat hydrocracking catalyst.
